(19) United States
(12) Patent Application Publication
(10) Pub. No.: US 2011/0094358 A1
(43) Pub. Date: Apr. 28, 2011

(54) PUNCH FOR PUNCHING SHEET METAL, SHEET METAL PUNCHING APPARATUS HAVING THE PUNCH, AND METHOD THEREFOR

(76) Inventors: Teruo Aramizu, Kanagawa (JP); Masatoshi Oishi, Hiroshima (JP)

(21) Appl. No.: 12/999,807

(22) PCT Filed: Jun. 18, 2008
(86) PCT No.: PCT/JP2008/001576

§ 371 Date: Dec. 17, 2010

(51) Int. Cl. B21D 28/34; B26F 1/14; B26F 1/00

(52) U.S. Cl. 83/52; 83/688; 83/685

(57) ABSTRACT

A sheet metal punching apparatus 1 includes: an upper die holder 2 which is raised and lowered by a hydraulic ram and the like; a pressing plate 3 secured to the upper die holder 2; a pressing pad 5 suspended from the upper die holder 2 through a resilient member 4; a punch holder 7 secured to the pressing pad 5; a lower die 9 on which sheet metal 8 to be subjected to punching is placed; and a die 10 embedded in the lower die 9.

### TECHNICAL FIELD

The present invention relates to a punch for punching sheet metal, a sheet metal punching apparatus having the punch, and a method therefor.

### BACKGROUND ART

[Patent Document 1] JP-A-2005-262263

[Patent Document 2] JP-A-2002-153920

A punching apparatus has been proposed in which a punch, which includes a cylindrical punch body having a smaller outside diameter than the hole diameter of a die and a conical projection formed integrally on one end face of this punch body, is pressed against sheet metal to form in advance a pierced hole in the sheet metal by the projection of the punch. As the punch body is further inserted into a circular hole in the die from one end of the circular hole of that die in a state in which the movement of the sheet metal is restricted by the projection inserted in the pierced hole, the sheet metal is fractured in cooperation with the punch body around an annular edge of a cylindrical inner surface of the die, which defines one end of the circular hole of the die, to thereby form a through hole in the sheet metal (e.g., refer to Patent Documents 1 and 2).

### DISCLOSURE OF THE INVENTION

### Problems that the Invention is to Solve

According to such a punching apparatus, the sheet metal is positioned by the projection, and a through hole is formed by applying mainly a tensile force rather than a shearing force to the sheet metal, so that the through hole can be formed accurately in the sheet metal without producing burrs. However, if the hole diameter of the through hole to be formed in the sheet metal becomes small, the annular end face of the punch body, which applies the tensile force to the sheet metal in cooperation with the annular edge of the cylindrical inner surface of the die, substantially ceases to exist owing to a curved portion of the outer peripheral edge of that end face and the bottom surface of the projection. Hence, there is a possibility that the pierced hole itself becomes enlarged in diameter by the punch body, following the formation of the pierced hole in the sheet metal by the projection of the punch, thereby making it impossible to form a through hole in the sheet metal by the tensile force.

Accordingly, if the expanse of the bottom plane of the projection is made small by decreasing the cone angle at the tip of the conical projection so as to secure the end face of a fixed size (expanse) in the punch body, the projection becomes extremely slender, which makes it difficult to ensure the strength of the projection and deteriorates the durability. On the other hand, if the expanse of the bottom plane of the projection is made small by instead making the overall height of the projection low, the projection is prone to come off the pierced hole after the formation of the pierced hole by the projection, making it difficult to effect the restriction of the movement of the sheet metal. Hence, there is a possibility that it becomes impossible to apply a tensile force uniformly to the sheet metal by the end face of the punch body in cooperation with the annular edge of the cylindrical inner surface of the die.

The present invention has been devised in view of the above-described aspects, and its object is to provide a punch for punching sheet metal which is capable of ensuring the strength of the projection and does not cause the deterioration of durability despite the fact that the end face of a fixed size (expanse) can be secured in the punch body, and which is capable of positioning the sheet metal by ensuring the restriction of the movement of the sheet metal by the projection even after the formation of the pierced hole, and is capable of avoiding the enlargement in diameter of the pierced hole itself by the punch body, thereby making it possible to form a through hole in the sheet metal by reliably fracturing by tension the sheet metal around the annular edge of the cylindrical inner surface of the die defining one end of the hole of the die in cooperation with the punch body, as well as a sheet metal punching apparatus having the punch, and a method therefor.

### Means for Solving the Problems

A punch for punching sheet metal in accordance with the present invention comprises: a punch body formed in the shape of a cylinder and a projection provided integrally on one end face of the body, wherein the projection includes a cylindrical portion provided integrally on the one end face of the punch body and having a bottom plane and a top plane, and a conical or pyramidal portion provided integrally on the top plane of the cylindrical portion, and the punch body includes a cylindrical surface extending in parallel to an axis, an annular surface surrounding the bottom plane of the cylindrical portion and extending perpendicularly to the axis, and a curved surface extending from an outer edge of the annular surface to one edge of the cylindrical surface.

According to the above-described punch for punching sheet metal, the projection has a cylindrical portion provided integrally on one end face of the punch body and having a bottom plane and a top plane. Therefore, even if the apex angle of the conical or pyramidal portion of the projection is made large so as to be able to obtain sufficient strength and durability, and the overall height of the projection is made high so as to prevent the coming off of the projection from the pierced hole after the formation of the pierced hole by the projection, the annular surface, which surrounds the bottom plane of the cylindrical portion of the projection and extends perpendicularly to the axis, can be secured with a sufficient expanse on the end face of the punch body. Thus, it is possible to avoid the enlargement in diameter of the pierced hole itself by the punch body, and the sheet metal can be reliably fractured by tension around the annular edge of the cylindrical inner surface of the die, which defines one end of the hole of the die, in cooperation with the punch body, thereby making it possible to accurately form a through hole in the sheet metal without producing burrs.

The punch for punching sheet metal in accordance with the present invention may be used in a sheet metal punching apparatus which is adapted to punch a pierced hole in sheet metal by the projection, and the punch is further inserted into a hole of a die from one end of the hole of the die in a state in which the movement of the sheet metal is restricted by the cylindrical portion of the projection inserted in the pierced hole to thereby fracture the sheet metal around an annular edge of a cylindrical inner surface of the die defining one end of the hole of the die, so as to form a through hole in the sheet metal.

In the present invention, the punch body may be formed in the shape of a cylinder including a triangular cylinder, a quadrangular cylinder, and a polygonal cylinder, and the conical or pyramidal portion may be formed in the shape of a pyramid including triangular pyramid, a quadrangular pyramid, and a polygonal pyramid. In a preferred example, however, the punch body and the conical or pyramidal portion may be formed in the shape of a circular cylinder and a circular cone, respectively. In this case, the punch for punching sheet metal in accordance with the present invention may comprise: a punch body formed in the shape of a circular cylinder and a projection provided integrally on one circular end face of the punch body, wherein the projection includes a circularly cylindrical portion provided integrally on the one circular end face of the punch body and having a circular bottom plane and a circular top plane concentrically with that circular end face, and a conical portion provided integrally on the circular top plane of the circularly cylindrical portion, and the punch body includes a circularly cylindrical surface extending in parallel to an axis, a circularly annular surface surrounding the circular bottom plane of the circularly cylindrical portion and extending perpendicularly to the axis, and a curved surface extending from an outer edge of the circularly annular surface to one edge of the circularly cylindrical surface.

In the case of the hole punching punch having a circularly cylindrical punch body, it suffices that if it is assumed that a radius of the punch body is r1, a radius of curvature of the curved surface is r2, a radius of the circularly cylindrical portion is r3, a height of the circularly cylindrical portion is h, and a thickness of the sheet metal to be punched is t, then r3<r1−r2, and h>t+r3.

In a preferred example, the diameter of the circularly cylindrical punch body is in a range of from 1 mm to 25 mm, from 1 mm to 10 mm, or from 1 mm to 5 mm, but the present invention is not limited to the same.

The punch for punching sheet metal and having the circularly cylindrical punch body may be used in a sheet metal punching apparatus which is adapted to punch a pierced hole in sheet metal by the projection, and the punch is further inserted into a circular hole of a die from one end of the circular hole of the die in a state in which the movement of the sheet metal is restricted by the circularly cylindrical portion of the projection inserted in the pierced circular hole to thereby fracture the sheet metal around a circularly annular edge of a circularly cylindrical inner surface of the die defining one end of the circular hole, so as to form a through hole in the sheet metal.

In the present invention, the circularly cylindrical portion of the projection may be a circularly cylindrical portion in which the circular bottom plane and the circular top plane are of the same diameter, or may alternatively be a circularly cylindrical portion of a so-called truncated conical shape in which the diameter of the circular top plane is smaller than the diameter of the circular bottom plane, and in which the angle of an apex in the case where a truncated conical surface is extended is smaller than the angle of the apex of the conical portion of the projection. In addition, to satisfactorily cause the tensile fracture of the sheet metal by reducing the effect of shear causing the burrs, the curved surface may have a radius of curvature R of from 0.1 mm to 5 mm.

An apparatus for punching sheet metal comprises: the punch for punching sheet metal according to any one of the above-described aspects; and a die having a hole or a circular hole into which the punch is inserted.

If the thickness of the sheet metal is assumed to be t, a difference as a clearance between the punch body and the hole or the circular hole of the die is sufficient if it is not less than 0.15 t and not more than 2 mm.

A method of forming a through hole in sheet metal by the above-described apparatus for punching sheet metal in accordance with the present invention comprises the steps of: forming a pierced hole in the sheet metal by the projection; and further inserting the punch into the hole or the circular hole of the die from one end of the hole or the circular hole in a state in which the movement of the sheet metal is restricted by the cylindrical portion or the circularly cylindrical portion of the projection inserted in the pierced hole to thereby fracture the sheet metal around the annular edge or the circularly annular edge of the cylindrical inner surface or the circularly cylindrical inner surface of the die defining one end of the hole or the circular hole.

As for the sheet metal which is punched by the punching apparatus or method in accordance with the present invention, to obtain a satisfactory result, its thickness is between 0.4 mm and 2.0 mm or thereabouts, but to obtain a more satisfactory result, its thickness is between 0.6 mm and 1.6 mm or thereabouts.

### ADVANTAGES OF THE INVENTION

According to the present invention, it is possible to provide a punch for punching sheet metal which is capable of ensuring the strength of the projection and does not cause the deterioration of durability despite the fact that the end face of a fixed size (expanse) can be secured in the punch body, and which is capable of positioning the sheet metal by ensuring the restriction of the movement of the sheet metal by the projection even after the formation of the pierced hole, and is capable of avoiding the enlargement in diameter of the pierced hole itself by the punch body, thereby making it possible to form a through hole in the sheet metal by reliably fracturing by tension the sheet metal around the annular edge of the cylindrical inner surface of the die defining one end of the hole of the die in cooperation with the punch body, as well as a sheet metal punching apparatus having the punch, and a method therefor.

Hereafter, a more detailed description will be given of the present invention on the basis of the preferred embodiment illustrated in the drawings. It should be noted that the present invention is not limited to such an embodiment.

### BRIEF DESCRIPTION OF THE DRAWINGS

FIG. 1 is a cross-sectional view of a preferred embodiment of the present invention;

FIG. 2 is an explanatory view of a portion of a punch used in the embodiment shown in FIG. 1;

FIG. 3 is a front elevational view of the punch shown in FIG. 2;

FIG. 4 is an explanatory diagram of the punch and a die used in the embodiment shown in FIG. 1;

FIG. 5 is a diagram explaining the operation of the embodiment shown in FIG. 1;

FIG. 6 is a diagram explaining the operation of the embodiment shown in FIG. 1;

FIG. 7 is a diagram explaining the operation of the embodiment shown in FIG. 1;

FIG. 8 is a diagram explaining the operation of the embodiment shown in FIG. 1; and

FIG. 9 is a diagram explaining the operation of a conventional example.

### BEST MODE FOR CARRYING OUT THE INVENTION

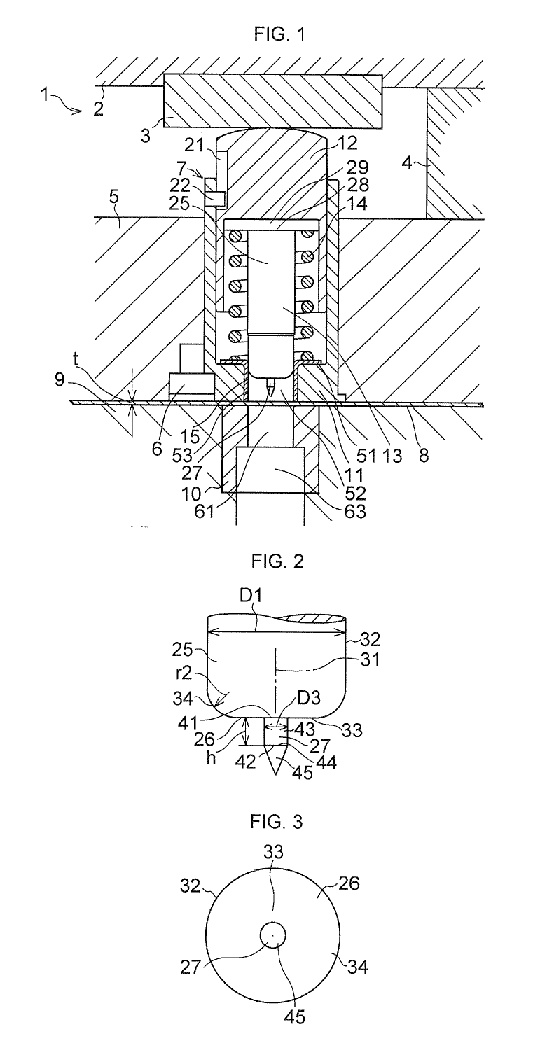

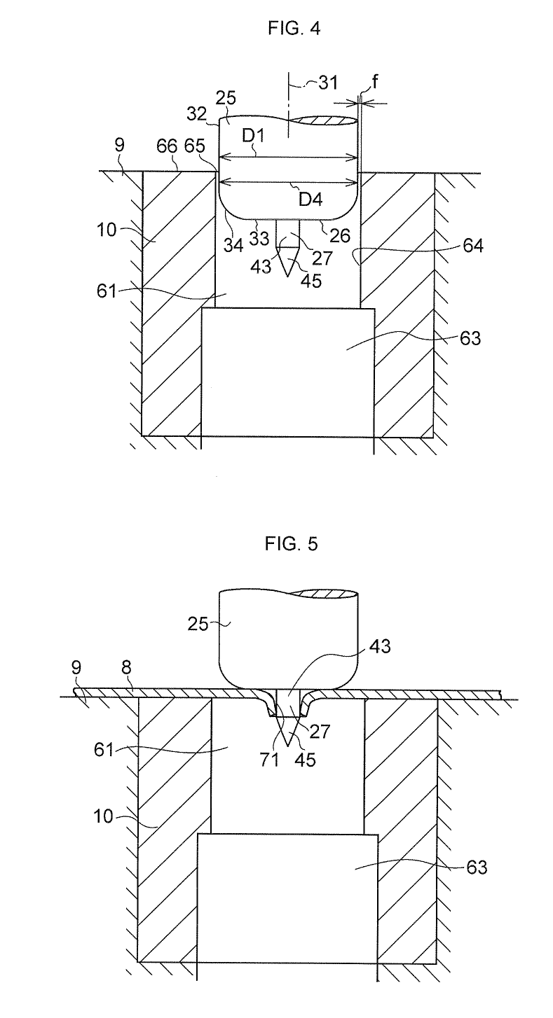

In FIGS. 1 to 4, a sheet metal punching apparatus 1 in accordance with this embodiment includes an upper die holder 2 which is raised and lowered by a hydraulic ram and the like; a pressing plate 3 secured to the upper die holder 2; a pressing pad 5 suspended from the upper die holder 2 through a resilient member 4; a punch holder 7 constructed as a punch unit secured to the pressing pad 5 by means of a bolt 6 and the like; a lower die 9 on which sheet metal 8 to be subjected to punching is placed; and a die 10 embedded in the lower die 9.

The punch holder 7 includes a hollow cylindrical case 11 secured to the pressing pad 5 by means of the bolt 6 and the like; a hollow cylindrical slider 12 fitted to the case 11 vertically slidably; a punch 13 fitted in the slider 12 vertically slidably; a returning means having a coil spring 14 which is disposed in the slider 12 and is adapted to return the punch 13 and the slider 12 to their initial positions by upwardly resiliently urging the slider 12 by means of the punch 13; and a slide guiding member 15 provided in the case 11 so as to guide the vertical movement of the punch 13.

The slider 12 has a recess 21, and is adapted to engage at the recess 21 a detent pin 22 secured to the case 11, so that the slider 12 does not come off the case 11 by the resiliency of the coil spring 14. The slider 12 is adapted to be pressed downward by the pressing plate 3 when the upper die holder 2 is lowered.

The punch 13 for punching the sheet metal 8 includes a punch body 25 formed in the shape of a circular cylinder; a projection 27 provided integrally on a circular end face 26 which is one end face of the punch body 25; and a collar 29 provided integrally on a circular end face 28 which is the other end face of the punch body 25.

The punch body 25 has a cylindrical surface 32 extending in parallel to an axis 31, an annular surface 33 extending perpendicularly to the axis 31, and a curved surface 34 extending from an outer edge of the circularly annular surface 33 to an outer edge of the cylindrical surface 32. A diameter D1 (=2×r1) of the punch body 25 is in a range of from 1 mm to 25 mm, from 1 mm to 10 mm, or from 1 mm to 5 mm, and a radius of curvature r2 of the curved surface 34 is in a range of from 0.1 mm to 5 mm.

The projection 27 includes a cylindrical portion 43 of a height h, which is disposed on the one circular end face 26 of the punch body 25 concentrically with that circular end face 26 and has a circular bottom plane 41 and a circular top plane 42 with a smaller diameter D3 (=2×r3) than the diameter D1 of the circular end face 26, the cylindrical portion 43 being provided integrally at the circular bottom plane 41; and a conical portion 45 which is disposed on the circular top plane 42 of the cylindrical portion 43 concentrically with that circular top plane 42 and has a circular bottom plane 44 with the same diameter as the diameter D3 of the circular top plane 42, the conical portion 45 being provided integrally at the circular bottom plane 44. The circular bottom plane 41 of the cylindrical portion 43 is surrounded by the annular surface 33 of the punch body 25.

In the above-described punch 13, if it is assumed that the radius of the punch body 25 is r1 (=D1×½), the radius of curvature of the curved surface 34 is r2, the radius of the cylindrical portion 43 is r3 (=D3×½), the height of the cylindrical portion 43 is h, and the thickness of the sheet metal 8 to be punched is t, then r3<r1−r2, and h>t+r3.

The coil spring 14 abuts against the collar 29 at one end thereof and a flange portion 51 of the slide guiding member 15 at the other end thereof The slide guiding member 15 has, in addition to the flange portion 51, a cylindrical portion 53 formed integrally with the flange portion 51 and fitted in the case 11 in a hole 52 of the case 11, and slidably guides and supports a lower end portion of the punch body 25 of the punch 13 by the inner peripheral surface of the cylindrical portion 53.

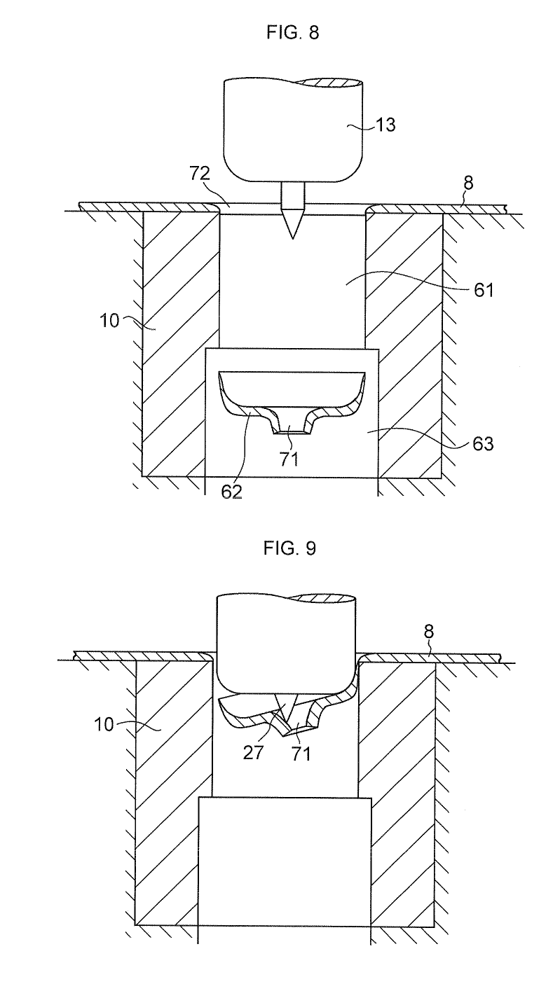

The die 10 has a circular hole 61 into which the punch 13 is inserted and a circular hole 63 which is continuous with the circular hole 61, is greater in diameter than the circular hole 61, and is adapted to discharge punch waste 62 (see FIG. 8). A ratio D1/D4 of a diameter D4 of the circular hole 61 to the diameter D1 of the circular end face 26 is not less than 0.80. If the thickness of the sheet metal 8 to be punched is assumed to be t, a difference (clearance) f between the radius r1 (=D1×½) of the circular end face 26 and a radius r4 (=D4×½) of the circular hole 61 of the die 10 is not less than 0.15 t and not more than 2 mm. The circular hole 61 is defined by a cylindrical inner surface 64 of the die 10, and one annular edge 65 of the cylindrical inner surface 64 is defined by an intersecting edge between the cylindrical inner surface 64 and one annular end face 66 of the die 10 perpendicular to that cylindrical inner surface 64 and forms a right-angled edge.

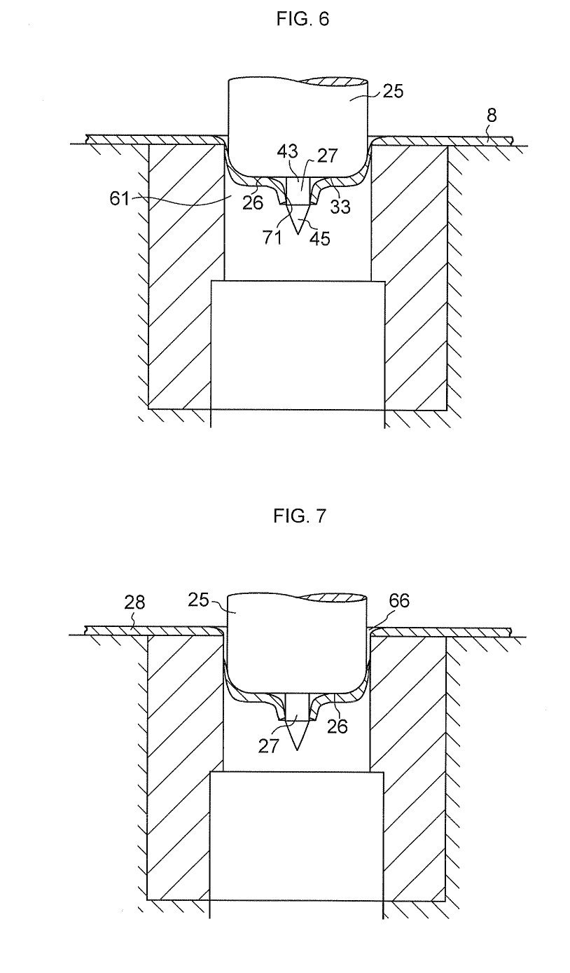

In the above-described punching apparatus 1, as the pressing plate 3, the pressing pad 5, and the punch holder 7 are lowered in conjunction with the lowering of the upper die holder 2, the sheet metal 8 placed on the lower die 9 is pressed by the pressing pad 5 and is fixed by being clamped between the lower die 9 and the pressing pad 5. At the same time, the slider 12 is pressed by the pressing plate 3, and the punch 13 is lowered in conjunction with the lowering of the slider 12. As the punch 13 is lowered, a pierced hole 71 is formed in the sheet metal 8 by the conical portion 45 of the projection 27 and subsequently by the cylindrical portion 43, as shown in FIG. 5. In a state in which the movement of the sheet metal 8 is restricted by the cylindrical portion 43 of the projection 27 inserted in the pierced hole 71, the punch 13 is further lowered, and the punch body 25 of the punch 13 is inserted into the circular hole 61 of the die 10, as shown in FIG. 6. Thereupon, the sheet metal 8 in contact with the annular surface 33 of the circular end face 26 is pressed by that annular surface 33 and is lowered together with the lowering of the punch body 25. In this lowering, the sheet metal 8, which is located between the curved surface 34 at the circular end face 26 and the annular edge 65 of the cylindrical inner surface 64 of the die 10 defining the one end of the circular hole 61 is pulled and elongated by the curved surface 34 at the circular end face 26 and the annular edge 65 of the cylindrical inner surface 64 of the die 10. Subsequently, the sheet metal 8 is torn off and fractured at the annular edge 65 side of the die 10, as shown in FIG. 7. After the fracturing of the sheet metal 8 at the annular edge 65 side of the die 10, the punch 13 is raised, as shown in FIG. 8, while the punch waste 62 is discharged through the circular hole 63. A through hole 72 is thus formed in the sheet metal 8.

Incidentally, with the punch 13, the projection 27 has the cylindrical portion 43 provided integrally on the one annular surface 33 of the punch body 25 and having the circular bottom plane 41 and the circular top plane 42. Therefore, even if the cone angle at the tip of the conical portion 45 of the projection 27 is made large so as to be able to obtain sufficient strength and durability, and the overall height of the projection 27 is made high so as to prevent the coming off of the projection 27 from the pierced hole 71 after the formation of the pierced hole 71 by the projection 27 (the coming off of the projection 27 from the pierced hole 71 in the conventional example is shown in FIG. 9), the annular surface 33, which surrounds the circular bottom plane 41 of the cylindrical portion 43 of the projection 27 and extends perpendicularly to the axis 31, can be secured with a sufficient expanse on the circular end face 26 of the punch body 25. Thus, the sheet metal 8 can be reliably fractured around the annular edge 65 of the cylindrical inner surface 64 of the die 10, which defines the one end of the circular hole 61 of the die 10, in cooperation with the punch body 25, thereby making it possible to accurately form the through hole 72 in the sheet metal 8.

Moreover, since the curved surface 34 has a radius of curvature r2 of between 0.1 mm and 5 mm, it is possible to reduce the effect of shear constituting the cause of burrs and fracture the sheet metal 8 by tension more satisfactorily. Furthermore, since the ratio D1/D4 is not less than 0.80, and the difference f is not less than 0.15 t, tensile fracture is mainly caused to occur in addition to slight shear, making it possible to effectively form the through hole 72 in the sheet metal 8.

With the punching apparatus 1, the through hole 72 is formed by vertically moving the punch 13, but the through hole 72 may be formed in an inclined portion of the sheet metal 8 by obliquely moving the punch 13.

1. A punch for punching sheet metal comprising: a punch body formed in the shape of a cylinder and a projection provided integrally on one end face of said body, wherein said projection includes a cylindrical portion provided integrally on the one end face of said punch body and having a bottom plane and a top plane, and a conical or pyramidal portion provided integrally on the top plane of said cylindrical portion, and said punch body includes a cylindrical surface extending in parallel to an axis, an annular surface surrounding the bottom plane of said cylindrical portion and extending perpendicularly to the axis, and a curved surface extending from an annular outer edge of the annular surface to an annular edge of the cylindrical surface.

2. The punch for punching sheet metal according to claim 1 for use in a sheet metal punching apparatus which is adapted to punch a pierced hole in sheet metal by said projection, and said punch is further inserted into a hole of a die from one end of the hole of said die in a state in which the movement of the sheet metal is restricted by said cylindrical portion of said projection inserted in the pierced hole to thereby fracture the sheet metal around an annular edge of a cylindrical inner surface of said die defining one end of the hole of said die, so as to form a through hole in the sheet metal.

3. A punch for punching sheet metal comprising: a punch body formed in the shape of a circular cylinder and a projection provided integrally on one circular end face of said punch body, wherein said projection includes a circularly cylindrical portion provided integrally on the one circular end face of said punch body and having a circular bottom plane and a circular top plane concentrically with that circular end face, and a conical portion provided integrally on the circular top plane of said circularly cylindrical portion, and said punch body includes a circularly cylindrical surface extending in parallel to an axis, a circularly annular surface surrounding the circular bottom plane of said circularly cylindrical portion and extending perpendicularly to the axis, and a curved surface extending from a circularly annular outer edge of the circularly annular surface to a circularly annular edge of the circularly cylindrical surface.

4. The punch according to claim 3, wherein if it is assumed that a radius of said punch body is r1, a radius of curvature of the curved surface is r2, a radius of said circularly cylindrical portion is r3, a height of said circularly cylindrical portion is h, and a thickness of the sheet metal to be punched is t, then r3<r1−r2, and h>t+r3.

5. The punch according to claim 3, wherein a diameter of said punch body is in a range of from 1 mm to 25 mm, from 1 mm to 10 mm, or from 1 mm to 5 mm.

6. The punch for punching sheet metal according to claim 3, for use in a sheet metal punching apparatus which is adapted to punch a pierced hole in sheet metal by said projection, and said punch is further inserted into a circular hole of a die from one end of the circular hole of said die in a state in which the movement of the sheet metal is restricted by said circularly cylindrical portion of said projection inserted in the pierced hole to thereby fracture the sheet metal around a circularly annular edge of a circularly cylindrical inner surface of said die defining one end of the circular hole, so as to form a through hole in the sheet metal.

7. An apparatus for punching sheet metal comprising: said punch for punching sheet metal according to claim 3, and a die having a circular hole into which said punch is inserted.

8. A method of forming a through hole in sheet metal by the apparatus for punching sheet metal according to claim 7, comprising the steps of: forming a pierced hole in the sheet metal by said projection; and further inserting said punch into the circular hole of said die from one end of the circular hole in a state in which the movement of the sheet metal is restricted by said circularly cylindrical portion of said projection inserted in the pierced hole to thereby fracture the sheet metal around the circularly annular edge of the circularly cylindrical inner surface of said die defining one end of the circular hole.
